(19) United States
(12) Patent Application Publication
(10) Pub. No.: US 2016/0144721 A1
(43) Pub. Date: May 26, 2016

(54) SYSTEM AND METHOD FOR OPTIMIZING REGENERATIVE BRAKING IN ADAPTIVE CRUISE CONTROL

(71) Applicant: FORD GLOBAL TECHNOLOGIES, LLC, Dearborn, MI (US)

(72) Inventors: Brian Thomas SOO, West Bloomfield, MI (US); Bernard D. NEFCY, Novi, MI (US); Francis Thomas CONNOLLY, Ann Arbor, MI (US); David Paul TOURNER, Novi, MI (US); Dale Scott CROMBEZ, Livonia, MI (US)

(21) Appl. No.: 14/548,344

(22) Filed: Nov. 20, 2014

(51) Int. Cl. B60L 7/26; B60W 20/00; B60K 6/48; B60W 30/14

(52) U.S. Cl. CPC B60L 7/26; B60W 30/14; B60W 20/00; B60K 6/48; Y10S 903/947

(57) ABSTRACT

A vehicle includes traction wheels, an electric machine configured to provide regenerative braking torque to the traction wheels, wheel brakes configured to provide friction braking torque to the traction wheels, and at least one power source configured to provide drive torque to the traction wheels. The vehicle additionally includes, a sensor configured to detect a forward object, and at least one controller. The controller is configured to control the power source, wheel brakes, and electric machine according to an adaptive cruise control (ACC) algorithm. The ACC algorithm is configured to command the electric machine to provide regenerative braking torque without application of the wheel brakes in response to a detected forward object and a maximum regeneration braking distance. The maximum regeneration braking distance is calculated based on a powertrain regenerative braking limit and a distance to the forward object.

### TECHNICAL FIELD

This disclosure relates to systems and methods for controlling the operation of an adaptive cruise control system in a vehicle equipped for regenerative braking

### BACKGROUND

Adaptive Cruise Control (ACC) systems use an on-board sensor (usually RADAR or LIDAR) to detect the distance between the host vehicle and a vehicle ahead of the host (the lead vehicle), and the relative speed difference between the vehicles. The system then automatically adjusts the speed of the host vehicle to keep it at a pre-set distance behind the lead vehicle, even in most fog and rain conditions. Typically, the host vehicle driver can set a desired/minimum following distance and/or a time gap to be maintained between vehicles. The ACC generates automatic interventions in the powertrain and/or braking systems of the host vehicle to slow the vehicle as necessary to maintain the selected minimum following distance.

### SUMMARY

A vehicle according to the present disclosure includes an electric machine configured to provide regenerative braking torque to the traction wheels, wheel brakes configured to provide friction braking torque to the traction wheels, and at least one power source configured to provide drive torque to the traction wheels. The vehicle additionally includes at least one controller. The controller is configured to control the power source, wheel brakes, and electric machine according to an adaptive cruise control (ACC) algorithm. The ACC algorithm is configured to command the electric machine to provide regenerative braking torque without application of the wheel brakes in response to a detected forward object and a maximum regeneration braking distance. The maximum regeneration braking distance is based on a powertrain regenerative braking limit and a distance to the detected forward object.

In one embodiment, the controller is further configured to override the ACC algorithm and control the electric machine and wheel brakes to satisfy a braking request in response to the braking request exceeding an associated threshold.

In an additional embodiment, the ACC algorithm is further configured to, in response to a power request and a detected forward object, control the at least one power source to provide a total power that is less than the power request. The total power has a magnitude based on a powertrain regenerative braking limit and a distance to the forward object. In such embodiments, the controller may be further configured to override the ACC algorithm and control the at least one power source to satisfy a power request in response to the power request exceeding an associated threshold.

In a further embodiment, the controller is further configured to, in response to a detected forward object, the ACC algorithm being inactive, and a driver brake request being less than an associated threshold, command the electric machine to provide regenerative braking torque without application of the wheel brakes based on a maximum regeneration braking distance. The maximum regeneration braking distance is based on a powertrain regenerative braking limit and a distance to the forward object. In still another embodiment, the at least one controller is further configured to, in response to a detected forward object, the ACC algorithm being inactive, and a driver power request being less than an associated threshold, control the at least one power source to provide a total power that is less than the power request. The total power has a magnitude based on a powertrain regenerative braking limit and a distance to the forward object.

A method of controlling a vehicle according to the present disclosure includes commanding the electric machine to provide regenerative braking torque based on a powertrain regenerative braking torque limit without applying vehicle friction brakes. The regenerative braking torque is applied via an electric machine. The command is in response to a detected forward object and no driver braking request.

In one embodiment, the method further includes, in response to the detected forward vehicle and a driver braking request not exceeding an associated threshold, continuing commanding the electric machine to provide regenerative braking torque based on a powertrain regenerative braking torque limit without applying vehicle friction brakes. In another embodiment, the method further includes, in response to the detected forward vehicle and a driver braking request exceeding an associated threshold, controlling the friction brakes to satisfy the driver braking request.

In an additional embodiment, the method further includes, in response to a detected forward vehicle, a driver power request not exceeding an associated threshold, and a powertrain regenerative braking torque limit, controlling at least one vehicle power source to provide a total power that is less than the power demand. The total power is based on the powertrain regenerative braking torque limit and a distance to the forward vehicle. In a further embodiment, the method additionally includes, in response to a detected forward vehicle, a driver power request exceeding an associated threshold, and a powertrain regenerative braking torque limit, controlling at least one vehicle power source to provide a total power to satisfy the driver power request.

A vehicle according to the present disclosure includes an electric machine configured to apply regenerative braking torque to traction wheels and at least one controller. The controller is configured to, in response to an anticipated deceleration requirement that is based on a presence of a detected forward object, automatically control the electric machine to apply regenerative braking torque based on a powertrain regenerative braking torque limit to satisfy the deceleration requirement without application of vehicle friction brakes.

In one embodiment, the controller is further configured to, in response to a driver brake request while the electric machine is automatically commanded to apply regenerative braking torque, when the brake request does not exceed an associated threshold, command the electric machine to continue providing regenerative braking torque without application of the friction brakes. In such an embodiment, the controller may be further configured to, in response to a driver brake request exceeding the associated threshold, control the friction brakes to satisfy the driver brake request exceeding the threshold.

In some embodiments, the controller is further configured to, in response to an anticipated deceleration event and a driver power demand, the driver power demand being less than an associated threshold, control at least one vehicle power source to provide a total power, the total power being less than the power demand and being based on the powertrain regenerative braking torque limit and a distance to the forward object. In such an embodiment the controller may be further configured to, in response to a driver power demand exceeding the associated threshold, control the at least one vehicle power source to provide a total power to satisfy the driver power demand exceeding the threshold.

In some embodiments, the controller is further configured to control vehicle acceleration and braking according to an adaptive cruise control algorithm. In such an embodiment, the controller may be further configured to reduce a cruise control algorithm power demand based on the powertrain regenerative braking torque limit. The controller may be configured to command the electric machine to apply a regenerative braking torque approximately equal in magnitude to the powertrain regenerative braking torque limit.

Embodiments according to the present disclosure provide a number of advantages. For example, the present disclosure provides a system and method of controlling an adaptive cruise control system that maximizes an amount of recaptured kinetic energy during a braking event. In addition, systems and methods according to the present disclosure provide for maximizing recaptured kinetic energy during braking when the ACC system is inactive.

The above advantage and other advantages and features of the present disclosure will be apparent from the following detailed description of the preferred embodiments when taken in connection with the accompanying drawings.

### BRIEF DESCRIPTION OF THE DRAWINGS

FIG. 1 is a schematic representation of a vehicle according to the present disclosure;

FIG. 2 illustrates a method of controlling a vehicle according to the present disclosure in flowchart form;

FIG. 3 illustrates a second method of controlling a vehicle according to the present disclosure in flowchart form; and

FIGS. 4A and 4B illustrate exemplary vehicle acceleration and braking events according to the present disclosure.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Adaptive Cruise Control (ACC) refers to a control method for automatically controlling a vehicle including maintaining both a desired speed and a safe distance from forward vehicles in the lane of travel. A host vehicle equipped with ACC is configured to maintain at least a predefined distance from a target vehicle positioned forward of the host vehicle. An ACC system generally includes at least one sensor, such as RADAR, LIDAR, ultrasonics, or other sensors or combination thereof. The ACC system is configured to directly or indirectly control throttle and brake systems to control vehicle acceleration and deceleration according to an ACC algorithm.

Some vehicles equipped with ACC systems may also include powertrains equipped for regenerative braking Regenerative braking refers to the recapture and storage of vehicle kinetic energy for subsequent use by the vehicle. Regenerative braking systems generally include an electric machine or motor/generator configured to apply braking torque to vehicle traction wheels and generate electric power. Other systems may include accumulators, flywheels, or other mechanisms for storing energy for subsequent use.

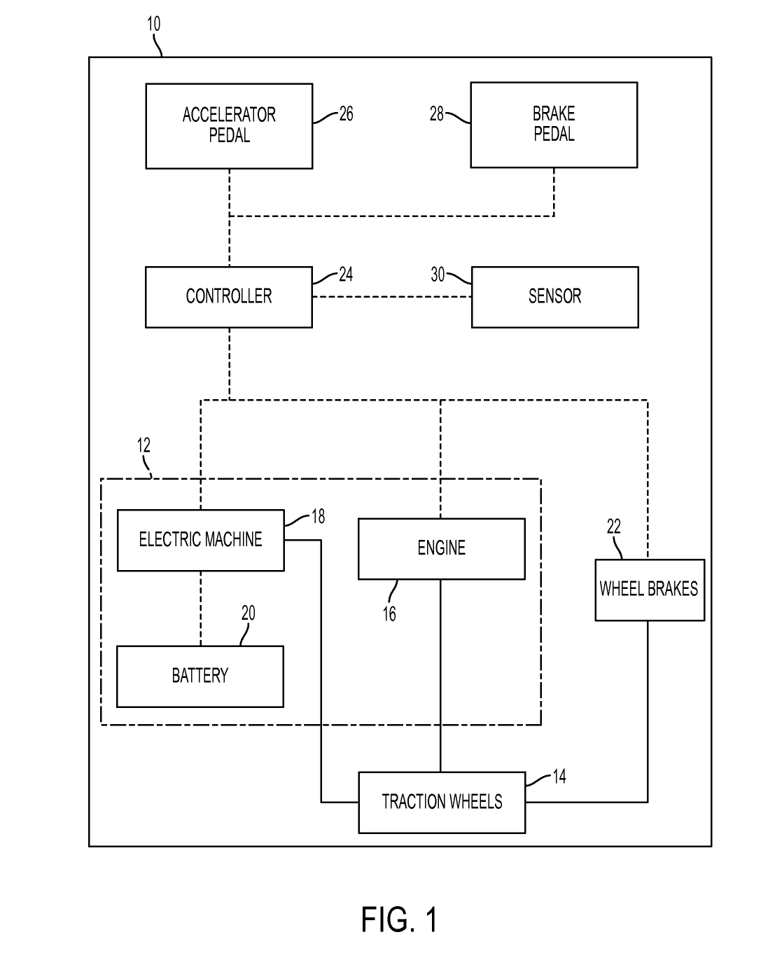

Referring now to FIG. 1, a vehicle 10 according to the present disclosure is illustrated in schematic form. The vehicle 10 includes a hybrid powertrain 12 configured to deliver power to traction wheels 14. The hybrid powertrain 12 includes an internal combustion engine 16 and at least one electric machine 18, each configured to deliver power to the vehicle traction wheels. The electric machine 18 is electrically coupled to a battery 20. In various embodiments, the powertrain 12 may be arranged as a series, parallel, or series-parallel powertrain.

The electric machine 18 is also configured provide regenerative braking torque to the traction wheels 14, in which rotational energy from the traction wheels 14 is converted to electrical energy. Electrical energy generated by the electric machine 18 may be stored in the battery 20 for subsequent use by the vehicle 10.

The vehicle 10 additionally includes wheel brakes 22 configured to provide friction braking torque to the traction wheels 14.

The electric machine 18, engine 16, and wheel brakes 22 are all in communication with or under the control of at least one controller 24. Although illustrated as a single controller, the controller 24 may be part of a larger control system and/or may be controlled by various other controllers throughout the vehicle 10. In one embodiment, the controller 24 is a powertrain control unit (PCU) under the control of a vehicle system controller (VSC). The controller 24 and one or more other controllers can collectively be referred to as a “controller.” The controller 24 may include a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller in controlling the engine or vehicle.

The vehicle 10 additionally includes an accelerator pedal 26 and a brake pedal 28. In response to a driver actuation of the accelerator pedal 26, the controller 24 is configured to coordinate the electric machine 18 and engine 16 to provide power to the traction wheels 14. In response to a driver actuation of the brake pedal 28, the controller 24 is configured to control the electric machine 18 and/or wheel brakes 22 to provide braking torque to the traction wheels 14.

Regenerative braking systems generally have a powertrain braking torque limit, referring to a maximum amount of braking torque the system is capable of applying to traction wheels under current operating conditions. In typical regenerative braking systems including an electric machine acting as a generator, the regenerative braking torque limit is generally based on motor torque capabilities, current gear in embodiments having a step-ratio transmission, battery energy delivery limits (e.g. a battery state of charge), and other powertrain limits.

In response to a brake request that does not exceed the regenerative braking torque limit, the controller 24 is configured to control the electric machine 18 to provide regenerative braking torque to satisfy the braking request. In response to a braking request that does exceed the regenerative braking torque limit, the controller 24 is configured to control the electric machine 18 and wheel brakes 22 to satisfy the braking request.

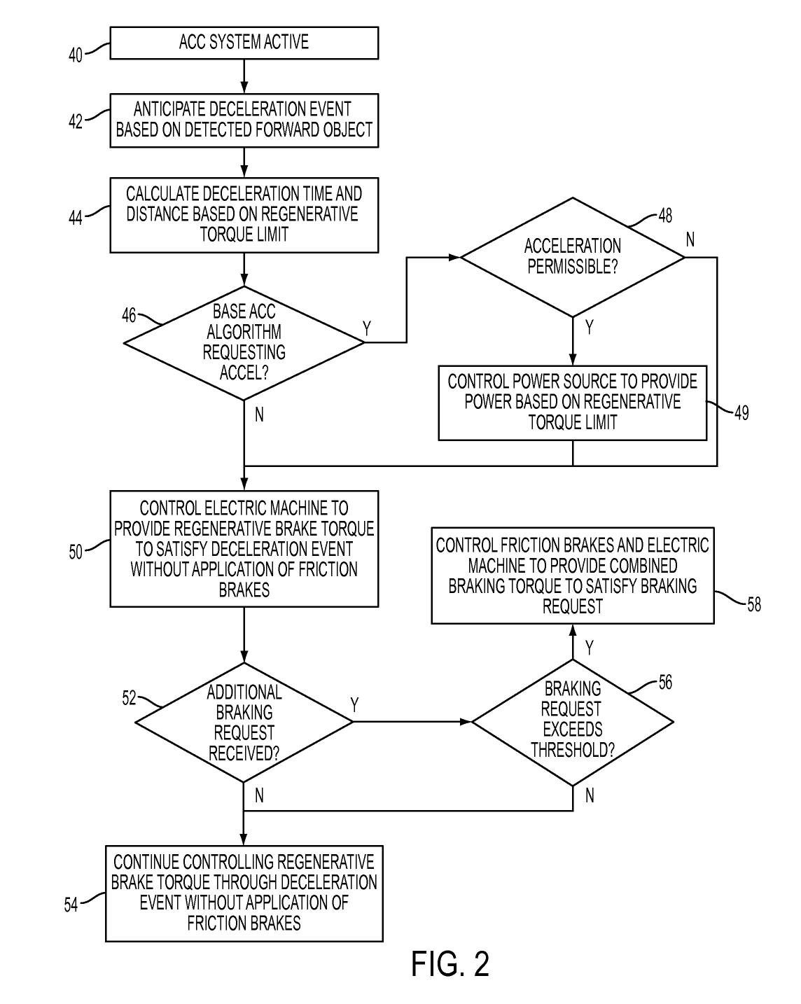

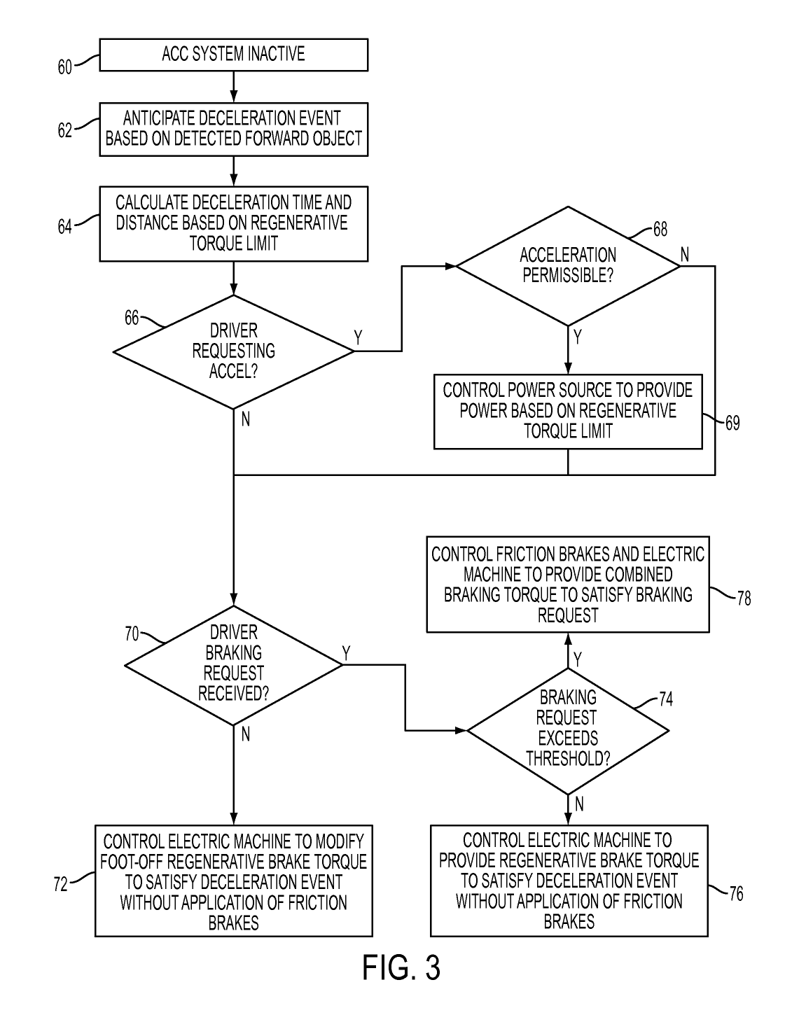

The vehicle 10 further includes at least one sensor 30. The sensor 30 may include RADAR, LIDAR, ultrasonic sensors, or other sensors or a combination thereof. The sensor 30 is configured to detect objects forward of the vehicle 10. In particular, the sensor 30 is oriented to detect a vehicle forward and in a same driving lane as the vehicle 10. The controller 24 is configured to control the control vehicle acceleration and braking according to an ACC algorithm in response to detection of a forward vehicle via the sensor 30, as will be discussed below with respect to FIGS. 2 and 3. This may include coordinating the engine 16 and/or electric machine 18 to satisfy an ACC acceleration request. This may additionally include coordinating the engine 16, electric machine 18, and/or wheel brakes 22 to satisfy an ACC deceleration request.

Referring now to FIG. 2, a method of controlling a vehicle according to the present disclosure is illustrated in flowchart form. The method begins with the ACC active, as illustrated in block 40. A deceleration event is anticipated based on a detected forward object, as illustrated at block 42. The deceleration event may correspond to a detected forward vehicle in a same lane as the host vehicle, when the forward vehicle is traveling more slowly than the host vehicle.

A deceleration time and distance are calculated, as illustrated at block 44. Notably, the deceleration time and distance are calculated based on a powertrain regenerative torque limit. In a preferred embodiment, the deceleration time and distance correspond to the time and distance required to decelerate the vehicle while the electric machine provides regenerative torque to the traction wheels, with the regenerative torque magnitude being approximately equal to the powertrain regenerative torque limit.

A determination is made of whether the ACC algorithm is requesting that the vehicle accelerate, as illustrated at operation 46. This may occur, for example, when the cruise control set speed is set higher than the current speed of the vehicle. If yes, then a determination is made of whether acceleration is permissible, as illustrated at operation 48. This may include, for example, comparing the deceleration distance calculated at block 44 with the distance to the forward object.

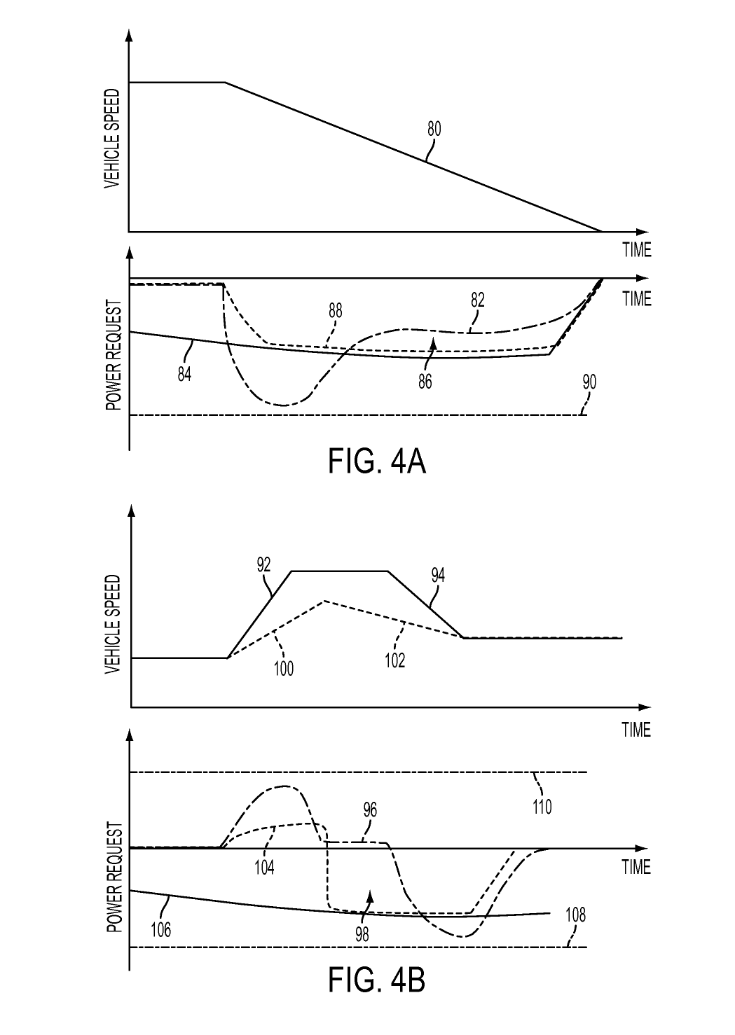

If acceleration is permissible, then at least one vehicle power source, such as an electric machine or internal combustion engine, is controlled to provide power to the vehicle wheels, as illustrated at block 49. The magnitude of the power provided to the wheels is based on the powertrain regenerative torque limit, such that the vehicle speed is maintained within a range that the vehicle may be subsequently decelerated based on the detected forward object without application of friction brakes. Notably, the power provided to the wheels may be less than the power requested by known ACC algorithms. This will be discussed in further detail below in conjunction with FIG. 4B.

Subsequently, the electric machine is controlled to provide regenerative brake torque to satisfy the deceleration event without application of friction brakes, as illustrated at block 50. Similarly, if a determination is made at operation 48 that acceleration is impermissible, or at operation 46 that the ACC algorithm is not requesting power, the electric machine is controlled to provide regenerative brake torque at block 50. The magnitude of the regenerative brake torque is based on a powertrain regenerative brake torque limit. In a preferred embodiment, the magnitude of the regenerative brake torque is approximate equal to the powertrain regenerative torque limit. The vehicle is thus decelerated based on the detected forward object without use of friction brakes.

A determination is then made of whether an additional braking request is received, as illustrated at operation 52. This may include, for example, a driver braking request, or an additional ACC braking request based on a deceleration of the forward object. If no, then the electric machine continues to be controlled to provide regenerative brake torque through the deceleration event without application of friction brakes as illustrated at block 54. If yes, then a determination is made of whether the braking request exceeds an associated threshold, as illustrated at operation 56. If no, then the electric machine continues to be controlled to provide regenerative brake torque at block 54. If yes, then the electric machine and friction brakes are controlled to provide a combined braking torque to satisfy the braking request, as illustrated at block 58. In this fashion, a heavy application of the brake pedal or a large increase in ACC braking request may be satisfied through use of friction brakes while sacrificing a portion of recapturable kinetic energy.

As may be seen, the above provides an ACC algorithm configured to maximize recaptured kinetic energy during braking events, while also providing adequate braking torque to satisfy driver or ACC braking requests. Similarly, the ACC sensors and system may be utilized to maximize recaptured kinetic energy during braking events even when the ACC system is turned off, as will be discussed below.

Referring now to FIG. 3, another method of controlling a vehicle according to the present disclosure is illustrated in flowchart form. The method begins with the ACC inactive, as illustrated in block 60. A deceleration event is anticipated based on a detected forward object, as illustrated at block 62. The deceleration event may correspond to a detected forward vehicle in a same lane as the host vehicle, when the forward vehicle is traveling more slowly than the host vehicle.

A deceleration time and distance are calculated, as illustrated at block 64. As in the method illustrated in FIG. 2, the deceleration time and distance are calculated based on a powertrain regenerative torque limit. In a preferred embodiment, the deceleration time and distance correspond to the time and distance required to decelerate the vehicle while the electric machine provides regenerative torque to the traction wheels, with the regenerative torque magnitude being approximately equal to the powertrain regenerative torque limit.

A determination is made of whether the driver is requesting that the vehicle accelerate by application of the accelerator pedal, as illustrated at operation 66. If yes, then a determination is made of whether acceleration is permissible, as illustrated at operation 68. This may include, for example, comparing the deceleration distance calculated at block 64 with the distance to the forward object.

If acceleration is permissible, then at least one vehicle power source, such as an electric machine or internal combustion engine, is controlled to provide power to the vehicle wheels, as illustrated at block 69. The magnitude of the power provided to the wheels is based on the powertrain regenerative torque limit, such that the vehicle speed is maintained within a range that the vehicle may be subsequently decelerated based on the detected forward object without application of friction brakes. Notably, the power provided to the wheels may be less than the power requested by driver via the accelerator pedal. This will be discussed in further detail below in conjunction with FIG. 4B.

A determination is then made of whether a driver braking request is received, e.g. by application of a brake pedal, as illustrated at operation 70. Similarly, if a determination is made at operation 68 that acceleration is impermissible, or at operation 66 that the driver is not requesting power, control proceeds to operation 70.

If no, then the electric machine is controlled to modify a “foot-off” regenerative brake torque to satisfy the deceleration event without application of vehicle brakes, as illustrated at block 72. The foot-off torque refers to the quantity of regenerative braking torque the electric machine provides in response to a driver releasing the accelerator pedal. The magnitude of the modified foot-off regenerative brake torque is based on a powertrain regenerative brake torque limit. In a preferred embodiment, the magnitude of the regenerative brake torque is approximate equal to the powertrain regenerative torque limit. The vehicle is thus decelerated based on the detected forward object without use of friction brakes.

If no driver braking request is received, a determination is then made of whether the braking request exceeds an associated threshold, as illustrated at operation 74. If no, then the electric machine is controlled to provide regenerative brake torque to satisfy the deceleration event without application of vehicle brakes, as illustrated at block 76. Notably, the provided torque may be less than or greater than the driver braking request. If yes, then the electric machine and friction brakes are controlled to provide a combined braking torque to satisfy the braking request, as illustrated at block 78. In this fashion, a heavy application of the brake pedal may be satisfied through use of friction brakes while sacrificing a portion of recapturable kinetic energy.

Variations on the above method are, of course, possible. For example, the vehicle may be provided with an “ECO MODE” button. Various vehicle systems may be configured to operate in a first mode in response to the ECO MODE button being inactive and a second mode in response to the ECO MODE button being active. In one embodiment, a system according to the present disclosure is configured to control the electric machine with the ACC system inactive, as discussed above, only when the ECO MODE button is active.

Referring now to FIG. 4A, an exemplary braking event according to the present disclosure is illustrated. In response to a detected forward object, a controller determines that a deceleration is necessary, as illustrated at 80. The deceleration event includes an associated deceleration distance and deceleration time. A driver may apply a brake pedal inconsistently, as illustrated at 82. During such an inconsistent application of the brake pedal, heavier portions of the driver brake request would necessitate coordinate regenerative braking and friction braking to provide braking torque to satisfy the calculated deceleration. This coordination in known systems is performed without regard to the regenerative braking torque limit, illustrated at 84. Similarly, known ACC systems are configured to coordinate regenerative braking and friction braking to provide braking torque, without regard to the regenerative braking limit. In either scenario, the coordinated braking may not recapture the maximum amount of kinetic energy, as illustrated in the region of “missed” regenerative capacity at 86.

In a system according to the present disclosure, the ACC algorithm may calculate a deceleration distance and deceleration time based on the regenerative torque limit and the distance to the forward vehicle. The system may subsequently coordinate regenerative and friction braking to maximize the recaptured regenerative capacity. In a preferred embodiment, this includes controlling an electric machine to provide regenerative braking torque approximately equal to the regenerative braking torque limit without applying wheel brakes, as illustrated at 88. Systems according to the present disclosure may, as a result, begin application of braking torque earlier than known methods.

In a preferred embodiment, the ACC system is provided with a braking torque request threshold, as illustrated at 90. In response to a brake request that does not exceed the threshold, the ACC system is controlled as described above. In response to a brake request that does exceed the threshold, the logic described above is overridden and the wheel brakes are applied to satisfy the brake request. Thus, during typical operation the system may maximize the recaptured kinetic energy, while in response to a sufficiently high braking request the system may engage wheel brakes to ensure that the braking request is satisfied.

Referring now to FIG. 4B, an exemplary acceleration event is illustrated. A driver or a base ACC requests acceleration, as illustrated at 92. A forward object, such as a forward vehicle in a same lane as the host vehicle, necessitates a subsequent deceleration, as illustrated at 94. The driver or base ACC power request for this maneuver, illustrated at 96, may be less efficient, resulting in “missed” regenerative capacity as illustrated at 98.

In a system according to the present disclosure, the ACC algorithm may calculate a deceleration distance and deceleration time based on the regenerative torque limit and the distance to the forward vehicle. The system may modify the acceleration request, as illustrated at 100, and subsequently coordinate regenerative and friction braking to maximize the recaptured regenerative capacity, as illustrated at 102. The acceleration request is modified such that the vehicle may satisfy In a preferred embodiment, this includes controlling an electric machine to provide regenerative braking torque, illustrated at 104, approximately equal to the regenerative braking torque limit without applying wheel brakes, illustrated at 106.

In a preferred embodiment, the ACC system is provided with a braking torque request threshold, as illustrated at 108, and an acceleration request threshold, as illustrated at 110. In response to a brake request that does not exceed the braking threshold 108 or an acceleration request that does not exceed the acceleration threshold 110, the ACC system is controlled as described above. In response to a brake request that does exceed the braking threshold 108, the logic described above is overridden and the wheel brakes are applied to satisfy the brake request. Similarly, in response to an acceleration request that does exceed the acceleration threshold 110, the logic described above is overridden and at least one vehicle power source is controlled to satisfy the acceleration request. Thus, during typical operation the system may maximize the recaptured kinetic energy, while in response to a sufficiently high braking or acceleration request the system may ensure that the request is satisfied.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A vehicle comprising:
an electric machine configured to provide regenerative braking torque to traction wheels;
wheel brakes configured to provide friction braking torque to the traction wheels;
at least one power source configured to provide drive torque to the traction wheels; and
at least one controller configured to command the electric machine to provide regenerative braking torque without application of the wheel brakes in response to a detected forward object and a maximum regeneration braking distance, the maximum regeneration braking distance being based on a powertrain regenerative braking limit and a distance to the detected forward object.

2. The vehicle of claim 1, wherein the controller is further configured to, in response to a braking request exceeding an associated threshold, control the electric machine and wheel brakes to satisfy the braking request.

3. The vehicle of claim 1, wherein the controller is further configured to, in response to a power request and a detected forward object, control the at least one power source to provide a total power, the total power being less than the power request and having a magnitude based on a powertrain regenerative braking limit and a distance to the forward object.

4. The vehicle of claim 3, wherein the controller is further configured to, in response to a power request exceeding an associated threshold, control the at least one power source to satisfy the power request.

5. The vehicle of claim 1, wherein the at least one controller is further configured to, in response to a detected forward object, an adaptive cruise control system being inactive, and a driver brake request being less than an associated threshold, command the electric machine to provide regenerative braking torque without application of the wheel brakes based on a maximum regeneration braking distance, the maximum regeneration braking distance being based on a powertrain regenerative braking limit and a distance to the forward object.

6. The vehicle of claim 1, wherein the at least one controller is further configured to, in response to a detected forward object, an adaptive cruise control system being inactive, and a driver power request being less than an associated threshold, control the at least one power source to provide a total power, the total power being less than the driver power request and having a magnitude based on a powertrain regenerative braking limit and a distance to the forward object.

7. A method of controlling a vehicle comprising:
in response to a deceleration requirement that is based on a presence of a detected forward vehicle, automatically applying regenerative braking torque via an electric machine to satisfy the deceleration requirement without applying friction brakes, the regenerative braking torque being based on a maximum regeneration braking distance and having a magnitude based on a powertrain regenerative braking torque limit.

8. The method of claim 7, further comprising, in response to the deceleration requirement and a braking request not exceeding an associated threshold, continuing to apply regenerative braking torque without applying the friction brakes based on the powertrain regenerative braking torque limit.

9. The method of claim 7, further comprising, in response to the deceleration requirement and a braking request exceeding an associated threshold, applying the friction brakes to satisfy the braking request.

10. The method of claim 7, further comprising, in response to a deceleration requirement based on a detected forward vehicle and a power demand not exceeding an associated threshold, controlling at least one vehicle power source to provide a total power, the total power being less than the power demand and being based on the powertrain regenerative braking torque limit and a distance to the forward vehicle.

11. The method of claim 7, further comprising, in response to a deceleration requirement based on a detected forward vehicle and a power demand exceeding an associated threshold, controlling at least one vehicle power source to provide a total power to satisfy the power demand.

12. A vehicle comprising:
an electric machine configured to apply regenerative braking torque to traction wheels; and
at least one controller configured to, in response to an anticipated deceleration requirement that is based on a presence of a detected forward object, automatically control the electric machine to apply regenerative braking torque based on a maximum regeneration braking distance and a powertrain regenerative braking torque limit to satisfy the deceleration requirement without application of vehicle friction brakes.

13. The vehicle of claim 12, wherein the at least one controller is further configured to, in response to a driver brake request while the electric machine is automatically commanded to apply regenerative braking torque, the brake request not exceeding an associated threshold, command the electric machine to continue providing regenerative braking torque without application of the friction brakes.

14. The vehicle of claim 13, wherein the at least one controller is further configured to, in response to a driver brake request exceeding the associated threshold, control the friction brakes to satisfy the driver brake request.

15. The vehicle of claim 12, wherein the at least one controller is further configured to, in response to an anticipated deceleration event and a driver power demand, the driver power demand being less than an associated threshold, control at least one vehicle power source to provide a total power, the total power being less than the power demand and being based on the powertrain regenerative braking torque limit and a distance to the forward object.

16. The vehicle of claim 15, wherein the at least one controller is further configured to, in response to a driver power demand exceeding the associated threshold, control the at least one vehicle power source to provide a total power to satisfy the driver power demand.

17. The vehicle of claim 12, wherein the at least one controller is further configured to control vehicle acceleration and braking according to an adaptive cruise control algorithm.

18. The vehicle of claim 17, wherein the at least one controller is further configured to reduce a cruise control algorithm power demand based on the powertrain regenerative braking torque limit.

19. The vehicle of claim 12, wherein the regenerative braking torque is approximately equal to the powertrain regenerative braking torque limit.
